(19) United States
(12) Patent Application Publication
(10) Pub. No.: US 2006/0146953 A1
(43) Pub. Date: Jul. 6, 2006

(54) Method and apparatus for estimating transmit weights for multiple antennas

(76) Inventors: Balaji Raghothaman, San Diego, CA (US); Jianzhong Zhang, Irving, TX (US); Yan Wang, Irving, TX (US); Marko Lampinen, Oulu (FI)

Correspondence Address: DITTHAVONG & CARLSON, P.C.;Suite A, 10507 Braddock Road, Fairfax, VA, 22032, US

(21) Appl. No.: 11/075,233

(22) Filed: Mar. 8, 2005

Related U.S. Application Data
(60) Provisional application No. 60/640,647, filed on Dec. 30, 2004.

(51) Int. Cl. H04B 7/02

(52) U.S. Cl. 375/267

(57) ABSTRACT

An approach for determining antenna weights in a multiple antenna communication system is provided. The approach jointly optimizes the transmitter weights and the receiver filter. A filter of a receiver (e.g., Linear Minimum Mean Square Error (LMMSE)) is optimized using initial weight values of the transmit antennas. The cost function, which is a mean-squared of a difference between a transmitted signal and an estimated signal, is then modified according to the optimized receiver filter. A transmit filter is then optimized according to the modified cost function. The above approach advantageously can obtain antenna weights when the condition of separability of paths does not exist.

### RELATED APPLICATIONS

This application is related to, and claims the benefit of the earlier filing date under 35 U.S.C. § 119(e) of, U.S. Provisional Patent Application (Ser. No. 60/640,647) filed Dec. 30, 2004, entitled “Method and Apparatus for Estimating Transmit Weights for Multiple Antennas”; the entirety of which is incorporated herein by reference.

### FIELD OF THE INVENTION

The present invention relates to communications, and more particularly, to a multiple antenna transmission system.

### BACKGROUND OF THE INVENTION

Multiple antenna communication systems have emerged to address the continual need for greater network capacity and availability by exploiting transmit diversity. Such systems are referred to as Multiple Input Multiple Output (MIMO) systems, and can encompass a multiple antenna configuration at the transmitter and a multiple or single antenna configuration at the receiver. MIMO systems improve system capacity by transmitting different data streams over the respective antennas, and thus, are suitable for high speed transmission applications. Under this arrangement, more users can be accommodated, or alternatively, a single user can be offered greater bandwidth.

Because of the spatial diversity gain, MIMO systems perform well in fading channel environments over traditional single antenna systems. The performance of MIMO systems is enhanced when channel information is available at the transmitter. The channel information is utilized to determine weighting values for transmission of data over the multiple antennas. Unfortunately, the determination of these antenna weighting values can be complex in a multipath channel, particularly a frequency selective channel.

Therefore, there is a need for an antenna weighting scheme that effectively accounts for multipath channels.

### SUMMARY OF THE INVENTION

These and other needs are addressed by the present invention, in which an approach is presented for determining antenna weights in a multiple antenna communication system.

According to one aspect of an embodiment of the present invention, a method for supporting transmission over a radio communication system is disclosed. The method includes applying an antenna weight vector to a plurality of antennas, wherein the antenna weight vector is generated by minimizing a cost function based on a transmitted signal and an estimated signal at a receiver. The cost function is jointly optimized according to a transmit filter and a receiver filter of the receiver. The method also includes transmitting a signal via the antennas over the radio communication system to the receiver.

According to another aspect of an embodiment of the present invention, an apparatus for supporting signal transmission is disclosed. The apparatus includes a plurality of antennas configured to transmit signals over a radio channel to a receiver. The apparatus also includes antenna weighting circuitry configured to generate an antenna weight vector by minimizing a cost function based on a transmitted signal and an estimated signal at the receiver. The cost function is jointly optimized according to a transmit filter and a receiver filter of the receiver. The circuitry is further configured to apply the generated antenna weight vector to the antennas.

According to yet another aspect of an embodiment of the present invention, a method for supporting signal transmission is disclosed. The method includes determining receiver filter weights based on a first set of transmitter filter weights. The method also includes modifying a cost function according to the determined receiver filter weights. Further, the method includes outputting a second set of transmitter filter weights according to the modified cost function, wherein the second set of transmitter filter weights are applied to a plurality of antennas for beamforming.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawings and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of a Multiple Input Multiple Output (MIMO) system for providing transmit diversity, according to various embodiments of the present invention;

FIG. 2 is a flowchart of a process for determining antenna weights, according to an embodiment of the present invention;

FIG. 3 is a graph showing performance comparison of a weighting scheme that assumes perfect path separability versus the weighting scheme of FIG. 2;

FIGS. 4-9 are graphs showing the performance of the system of FIG. 1 under various streaming schemes; and

FIG. 10 is a diagram of hardware that can be used to implement an embodiment of the present invention.

### DESCRIPTION OF THE PREFERRED EMBODIMENT

An apparatus, method, and software for determining antenna weights in a multiple antenna communication system are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

According to one embodiment of the present invention, an approach is provided for estimating the transmitter weights for a multiple antenna system, by jointly optimizing the transmitter weights and the receiver filter. In an exemplary embodiment, the cost function used is the mean squared of the difference between the transmitted signal and the estimated signal. This approach advantageously enhances system capacity for frequency selective multipath channels.

Although various embodiments of the present invention are described with respect to spread spectrum systems (e.g., code division systems), it is recognized that the present invention can be practiced in a variety of radio communication systems.

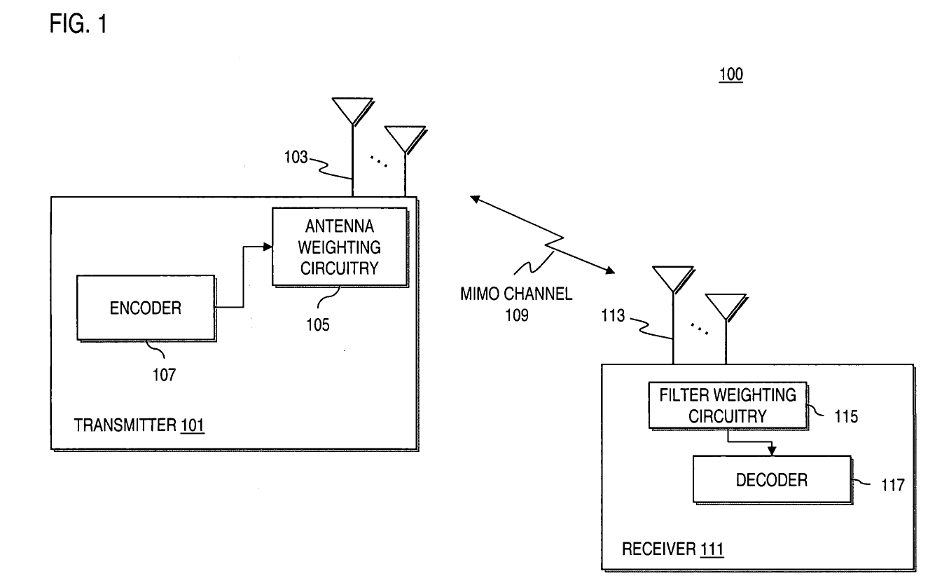

FIG. 1 is a diagram of a Multiple Input Multiple Output (MIMO) system for providing transmit diversity, according to various embodiments of the present invention. A MIMO system 100, in this example, includes a transmitter 101 that utilizes two or more antennas 103. The transmitter 101 employs antenna weighting circuitry 105 for applying weights to the various antennas 103. The transmitter 101 also includes an encoder 107 for encoding, for example using spread spectrum techniques, a data stream for transmission over the MIMO channel 109 to a receiver 111. The encoder 107 also provides encoding for space-time transmit diversity.

The MIMO system 100 can support Third Generation (3G) services as defined by the International Telecommunications Union (ITU) for International Mobile Telecommunications 2000 (IMT-2000). Thus, it is contemplated that the MIMO system 100, in an exemplary embodiment, supports packet data transmission in a spread spectrum system, such as CDMA2000 and High Speed Downlink Packet Access (HSDPA) in Wideband Code Division Multiple Access (WCDMA) system.

In a “beamforming” or similar weighted transmission scheme using multiple antennas, the weights to be used at the transmitter 103 are a function of the channel coefficients corresponding to the MIMO channel 109. Conventionally, a beamforming type of transmission has been targeted for flat fading channels. In multipath channels, RAKE combining has been usually assumed and feedback weight vector calculations typically consider similar combining of multipath components. In a flat fading channel, the antenna weights are simply the normalized conjugates of the channel coefficients. By contrast, with frequency selective multipath channels, as the MIMO channel 109, determining the antenna weights poses significant challenges.

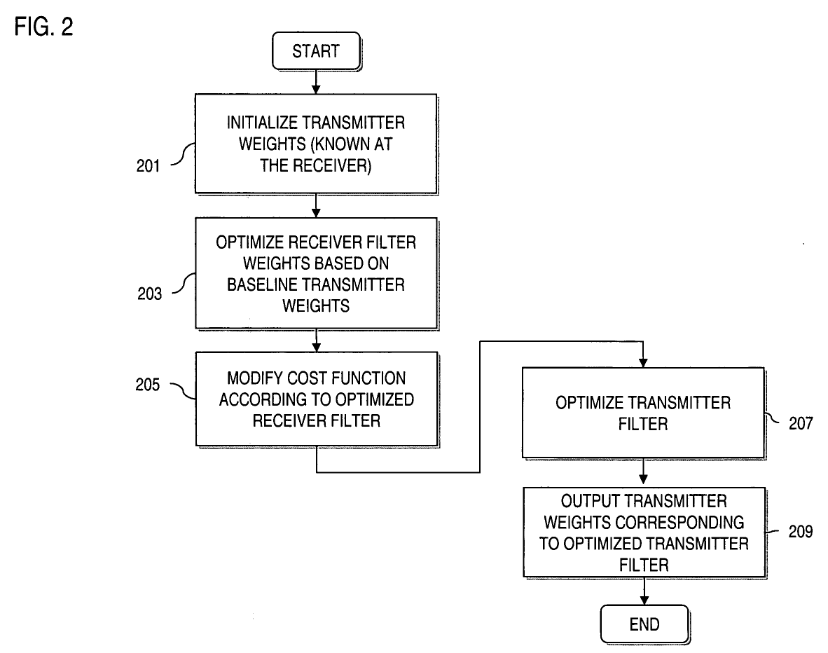

In a multipath channel (such as the MIMO channel 109), a few conventional approaches have been proposed. For example, in the presence of a “perfect” separability of the paths, which is approached by a CDMA system with very long spreading sequences, the weight vector is the principal eigenvector of the channel matrix, where the size of the channel matrix is the number of antennas by the number of paths in the channel. However, perfect separability is not achievable in practical systems. Based on this recognition, a weighting scheme is provided by the transmitter 101 of FIG. 1, whereby effective weighting values are obtained without the condition of separability. This antenna weighting scheme is more fully described below with respect to FIG. 2.

At the receiving end, the receiver 111 can utilize one or more antennas 113 to receive signals over the MIMO channel 109. The receiver 111 can be a mobile receiver, assuming the MIMO system 100 is operated in a cellular CDMA system, for instance. In an exemplary embodiment, the receiver 111 is a Linear Minimum Mean Square Error (LMMSE) receiver, and includes filter weighting circuitry 115 that is optimized with the antenna weights of the transmitter 101. The receiver 111 also has a decoder 117 for decoding the received signal from the transmitter 101.

FIG. 2 is a flowchart of a process for determining antenna weights, according to an embodiment of the present invention. This process, as implemented in the antenna weighting circuitry 105 of the transmitter 101, provides a mechanism for estimating transmitter weights by jointly optimizing the transmitter weights and the receiver filter. According to one embodiment of the present invention, the mean squared of the difference between the transmitted signal from the transmitter 101 and the estimated signal by the receiver 111 serves as the cost function.

In step 201, the antenna weights of the transmitter 101 are initialized. That is, the transmitter weights are assumed to be fixed and known by the receiver 111. Based on this assumption, the receiver filter weights are optimized, per step 203. These weight values for the receiver filter are a function of the transmitter weights.

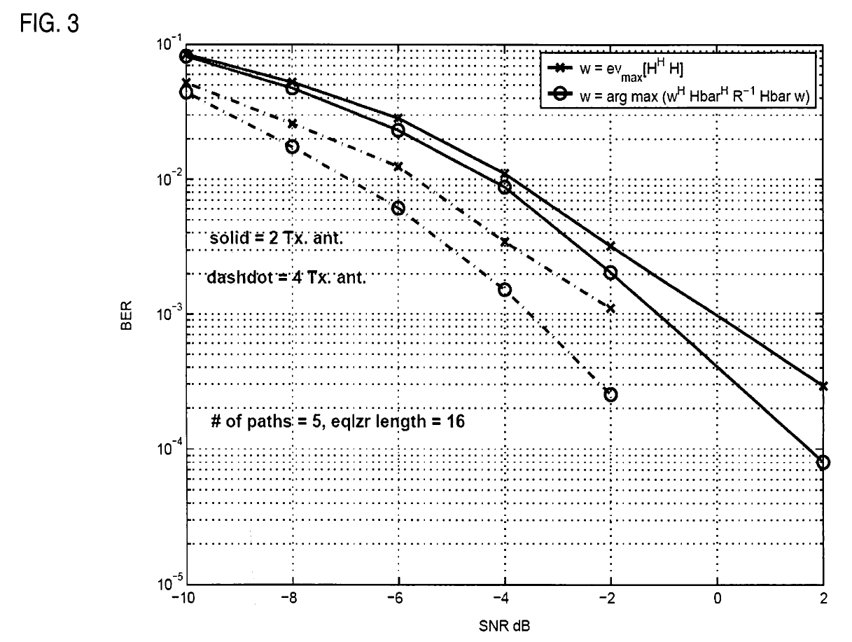

In step 205, the cost function is modified according to the optimized receiver filter. In other words, the cost function is rewritten in terms of the optimized receiver filter. An exemplary cost function (Eq. (11)) is later discussed. The optimization is then performed with respect to the transmit filter (step 207). The resultant weight vector is subsequently output, as in step 209. These transmitter weights are shown to improve the bit error rate performance over the traditional approach that assumes separability of paths (FIG. 3). For true frequency selective multipath channels, such traditional approaches have yielded transmitter weight vectors of a significantly larger size vis-à-vis the number of transmit antennas. This entails greater equipment cost and complexity.

Conventionally, an LMMSE-based receiver filter is designed to be many times the length of the channel itself. Consequently, use of a large preceding matrix at the transmitter is required; the size of the matrix also varies with the size of the receiver filter. By contrast, the process of FIG. 2 obtains a weight vector that has the same size as the number of transmit antennas 103. That is, the transmitter filter length is equal to the number of transmitter antennas only, and is independent of the length of the receiver antenna.

To better appreciate the weighting scheme of FIG. 2, it is instructive to understand the optimization problem associated with the transmitter and receiver weights. For the purposes of explanation, a wireless system with M transmitter antennas and one receiver antenna is considered. It is assumed that the channel from each transmit antenna to the receiver antenna is characterized as a frequency selective channel with L paths, i.e., h₁(k)=[h_{l,1}(k) . . . h_{l,M}(k)]^{T}, where l=1 , . . . , L is the multipath index, and k is the time index. Also, each symbol in the symbol stream is assumed to be transmitted simultaneously through all the M transmit antennas after weighting by the conjugate of a complex vector w_{T}∈C^{M×1}. The transmitted symbols are denoted by sₖ, k=−∞, . . . , ∞, with E[sₖsₖ*]=σₛ².

In the case of flat fading (L=1) or in multipath fading where the paths are perfectly separable, the received signal can be written as:

$${\overline{r}}_{k} = {[ {\overline{r}}_{k , 1} … {\overline{r}}_{k , L} ]}^{T} = [ \begin{matrix}{h}_{1}^{T} \\ {h}_{2}^{T} \\ ⋮ \\ {h}_{L}^{T}\end{matrix} ] {w}_{T}^{*} {s}_{k} + {n}_{k} = {\hat{H}}_{k} {w}_{T}^{*} {s}_{k} + {n}_{k} , \qquad Eq . ( 1 )$$

where \overline{r}_{k,l} denotes the l^{th} received path. In this case, the optimal solution for w_{T} is clearly given by
w_{T}^{opt}=evₘₐₓ*[Ĥₖ^{HĤ}ₖ]. Eq. (2)

Now, the general frequency selective channel case (e.g., the MIMO channel 109) is considered, whereby such separability between paths is not assumed. F denotes the length of the receiver filter w_{R}, where F>>L.
Hₖ∈C^{F×(F+L-1)}=Ĥ_{k.} (I_{F+l-1}Θw_{T}*), Eq. (3)

$$\begin{matrix}{\overline{H}}_{k} ∈ {C}^{F \times ( F + L - 1 )} = [ \begin{matrix}← & {\overline{H}}_{k} & \to & 0 & ⋯ & ⋯ \\ 0 & ← & {\overline{H}}_{k - 1} & \to & 0 & ⋯ \\ ⋮ & ⋮ & ⋮ & ⋮ & ⋮ & ⋮ \\ 0 & ⋯ & ⋯ & ← & {\overline{H}}_{k - F - L + 2} & \to \end{matrix} ] , & Eq . ( 4 ) \\ {\vec{H}}_{k} ∈ {C}^{1 \times ( ML )} = [ {h}_{1}^{T} ( k ) {h}_{2}^{T} ( k ) … {h}_{L}^{T} ( k ) ] . & Eq . ( 5 )\end{matrix}$$

In the above definitions, I_{P} is an identity of size P×P, and Θ denotes the Kronecker product.

Next, an F×1 vector of the received signal is considered, whereby the received signal is given by
rₖ=[rₖ . . . r_{k-F+1}]^{T}=Hₖsₖ+nₖ, Eq. (6)
where sₖ=[sₖ . . . s_{k-F-L+2}]^{T}, and nₖ is an additive white Gaussian noise vector with E[nₖnₖ^{H}]=σₙ²I_{F}. Henceforth, it is assumed that the channel is invariant during the F+L−1 symbol periods from (k−F−L+2) to k; the time subscripts are omitted where appropriate. For example, h₁(k) and h₁ are used interchangeably. It is noted that once the time-invariance is assumed, the matrix Hₖ described above is Toeplitz and rectangular in structure.

At the receiver 111, the linear filter w_{R}∈C^{F×1} is used to obtain an estimate of the desired symbol s_{d}, where d=k−F/2+D:
ŝ_{d}=w_{R}^{H}r_{k.} Eq. (7)

The cost function to be minimized is given by

$$\begin{matrix}J ( k ) = E [ {‖ {s}_{d} - {\hat{s}}_{d} ‖}^{2} ] & Eq . ( 8 ) \\ = {σ}_{s}^{2} - {σ}_{s}^{2} {e}_{d}^{T} {H}_{k}^{H} {w}_{R} - {σ}_{s}^{2} {w}_{R}^{H} {H}_{k} {e}_{d} - {σ}_{s}^{2} {w}_{R}^{H} {H}_{k} {H}_{k}^{H} {w}_{R} + {σ}_{n}^{2} {w}_{R}^{H} {w}_{R} , & Eq . ( 9 )\end{matrix}$$

where e_{d}∈ [symbol] ^{F+L-1×1}=[0_{1×(F/2-D)}1 0_{1×(F/2-D)}]^{T} is a vector with 1 in the (k−d+1)^{th} position and 0 in other all positions. It is noted that Hₖe_{d} is simply the (k−d+1)^{th} column of Hₖ, given by \check{H}_{k,d}w_{T}*, where \check{H}_{k,d} is an F×M band of \overline{H}ₖ (see Equation (14)).

The cost function defined in Equation (9) can be minimized in two steps, as explained earlier with respect to FIG. 2. First, the transmit filter w_{T} is assumed to be fixed, and the receiver filter w_{R} is optimized. The resultant solution for w_{R} will be a function of w_{T}. This solution is substituted back into the cost function expression, which is now optimized over the transmit filter w_{T}, in order to provide the joint solution. In the first step, setting

$$\frac{\partial J ( k )}{\partial {w}_{R}} = 0$$

provides the familiar LMMSE solution given by
w_{R}^{o}=σₛ²R⁻¹\check{H}_{k,d}w_{T}*, Eq. (10)
where R=(σₛ²HₖHₖ^{H}+σₙ²I_{F}).

Substituting the optimal receiver vector w_{R} into the cost function in Eq. (9) yields:
J=σₛ²(1−w_{T}^{T}\check{H}_{k,d}^{H}R⁻¹\check{H}_{k,d}w_{T}*). Eq. (11)

The values for the transmit beamformer vector are obtained by minimizing the above cost function, or equivalently, by maximizing \overline{J}=σₛ²−J.

To simplify the above analysis, it is convenient to consider an alternate formulation which makes the channel matrix square and circulant:

$${\tilde{r}}_{k} = {r}_{k} + [ \begin{matrix}0 & & & \\ {h}_{L}^{T} & 0 & ⋯ & \\ {h}_{L - 1}^{T} & {h}_{L}^{T} & 0 & ⋯ \\ ⋯ & & & \\ {h}_{2}^{T} & {h}_{3}^{T} & ⋯ & {h}_{L}^{T}\end{matrix} ] ( {I}_{L - 1} ⊗ {w}_{T}^{*} ) [ \begin{matrix}{s}_{k - F} \\ ⋮ \\ {s}_{k - F - L + 2}\end{matrix} ] - [ \begin{matrix}0 & & & \\ {h}_{L}^{T} & 0 & ⋯ & \\ {h}_{L - 1}^{T} & {h}_{L}^{T} & 0 & ⋯ \\ ⋯ & & & \\ {h}_{2}^{T} & {h}_{3}^{T} & ⋯ & {h}_{L}^{T}\end{matrix} ] ( {I}_{L - 1} ⊗ {w}_{T}^{*} ) [ \begin{matrix}{s}_{k} \\ ⋮ \\ {s}_{k - L + 2}\end{matrix} ] \qquad Eq . ( 12 )$$

From a practical standpoint, the formulation suggested above is approximated. This is because, as seen below, the objective of the receiver 111 (of FIG. 1) is to estimate the symbol

$${s}_{k - \frac{F}{2} + D} ,$$

where D denotes a delay. The symbols prior to that would already have been estimated, most likely including [s_{k-F-L+2} . . . s_{k-F}]^{T}, while the symbols that lie ahead of the currently estimated symbol (i.e., with a greater time index)—most likely include [s_{k-L+2} . . . sₖ]^{T}—have not yet been estimated. Thus, the first additive term in Equation (12) can be approximated using the estimated symbols, while the second cannot. However, the larger the filter length with respect to the channel (F>>L), the better this approximation. The modified form suggested in Eq. (12) can be rewritten as follows:
\tilde{r}ₖ=H_{C,k}sₖ+nₖ, Eq. (13)
where H_{C,k} ∈C^{F×F} is square and circulant. It is noted that the i^{th} column of H_{C,k} can be expressed as

$${h}_{C , i} ( k ) = [ \begin{matrix}{0}_{( i - L ) \times M} \\ {h}_{L} \\ ⋮ \\ {h}_{1} \\ {0}_{( F - i ) \times M}\end{matrix} ] {w}_{T}^{*} = {\breve{H}}_{i} ( k ) {w}_{T}^{*} , \qquad Eq . ( 14 )$$

In order to obtain this solution, the well-known property of circulant matrices—that they are diagonalizable by DFT matrices—is used. It has already been established that H_{C} is circulant. Hence, H_{C}=QΛ₁Q^{H}, where Q=[q₁q₂ . . . q_{F}] is the F×F unitary DFT matrix and Λ₁=diag (Q^{H}\check{H}_{C,1}w_{T}*) is a diagonal matrix composed from the DFT of the first column of H_{C}. It is recognized that it will be advantageous if the d^{th} column of \check{H}_{C,d}w_{T}* were used in the decomposition of H_{C} instead of the first column, since the d^{th} column occurs elsewhere in the cost function expression. In order to achieve this, the matrix H_{C}P_{d} is considered, where P_{d} is a permutation matrix which rotates the columns of H_{C} in such a manner that the d^{th} column moves to the first position. Such a rotation preserves the circular structure, and hence H_{C}P_{d}=QΛ_{d}Q^{H}, where Λ₁ is obtained from the first column of H_{C}P_{d}, i.e., the d^{th} column of H_{C}. Thus,

$$\begin{matrix}R = ( {σ}_{s}^{2} {H}_{C} {H}_{C}^{H} + {σ}_{n}^{2} {I}_{F} ) & Eq . ( 15 ) \\ = ( {σ}_{s}^{2} {H}_{C} {P}_{d} {P}_{d} {}_{}^{H}{H}{}_{C}^{H} + {σ}_{n}^{2} {I}_{F} ) , since {P}_{d} {P}_{d}^{H} = I , & Eq . ( 16 ) \\ = Q ( {σ}_{s}^{2} {Λ}_{d}^{2} + {σ}_{n}^{2} I ) {Q}^{H} , & Eq . ( 17 )\end{matrix}$$

and the cost function becomes

$$\begin{matrix} {\overline{J}}_{T} = {σ}_{s}^{2} {w}_{T}^{T} {\breve{H}}_{C , d}^{H} {Q ( {σ}_{s}^{2} {Λ}_{d}^{2} + {σ}_{n}^{2} I )}^{- 1} {Q}^{H} {\breve{H}}_{C , d}^{H} {w}_{T}^{*} , & Eq . ( 18 ) \\ = {σ}_{s}^{2} trace ( {w}_{T}^{T} {\breve{H}}_{C , d}^{H} {Q ( {σ}_{s}^{2} {Λ}_{d}^{2} + {σ}_{n}^{2} I )}^{- 1} {Q}^{H} {\breve{H}}_{C , d}^{H} {w}_{T}^{*} ) , since {\overline{J}}_{T} is a scalar & Eq . ( 19 ) \\ = {σ}_{s}^{2} trace ( {Q}^{H} {\breve{H}}_{C , d}^{H} {w}_{T}^{*} {w}_{T}^{T} {\breve{H}}_{C , d}^{H} {Q ( {σ}_{s}^{2} {Λ}_{d}^{2} + {σ}_{n}^{2} I )}^{- 1} ) , using trace ( AB ) = trace ( BA ) . & Eq . ( 20 )\end{matrix}$$

In order to simplify the above cost function further, the following inequality is examined: Given that A, B are m×m positive semi-definite,

$$trace ( AB ) \geq {\sum }_{i = 1}^{m} {λ}_{A , i} {λ}_{B , m - i + 1} ,$$

where λ_{A,i} and λ_{B,i} are the eigenvalues of A, B arranged in decreasing order. Using this property, a lower bound of the cost function is obtained as

$${\overline{J}}_{LB} = {\sum }_{i = 1}^{F} {λ}_{A , i} {λ}_{B , F - i + 1 ,} \\ where A = {Q}^{H} {\breve{H}}_{C , d} {w}_{T}^{*} {w}_{T}^{T} {\breve{H}}_{C , d}^{H} Q , \\ and B = {( {σ}_{s}^{2} {Λ}_{d}^{2} + {σ}_{n}^{2} I )}^{- 1} . \qquad Eq . ( 21 )$$

It can be seen that A is a rank-1 matrix and hence has only one non-zero eigen value:

$${λ}_{A , i} = \{ \begin{matrix}{w}_{T}^{T} {\breve{H}}_{C , d}^{H} \underbrace{{QQ}^{H}}_{= I} {\breve{H}}_{C , d} {w}_{T}^{*} & i = 1 , \\ 0 , & otherwise .\end{matrix} \} \qquad Eq . ( 22 )$$

Hence, the summation in Equation (21) reduces to one term:

$${\overline{J}}_{LB} = {λ}_{A , 1} {λ}_{B , F} \\ where \\ {λ}_{B , F} = {min}_{i} \{ \frac{1}{{σ}_{s}^{2} {q}_{i}^{H} {\breve{H}}_{C , d} {w}_{T}^{*} {w}_{T}^{T} {\breve{H}}_{C , d}^{H} {q}_{i} + {σ}_{n}^{2}} \} . \qquad Eq . ( 23 )$$

Assuming the index i that leads to λ_{B,F} is given by p, the following results:

$$\begin{matrix}{\overline{J}}_{LB} = \frac{{w}_{T}^{T} {\breve{H}}_{C , d}^{H} {\breve{H}}_{C , d} {w}_{T}^{*}}{{σ}_{s}^{2} {w}_{T}^{T} {\breve{H}}_{C , d}^{H} {q}_{P} {q}_{P}^{H} {\breve{H}}_{C , d} {w}_{T}^{*} + {σ}_{s}^{2}} , & Eq . ( 24 ) \\ = \frac{{w}_{T}^{T} {\breve{H}}_{C , d}^{H} {\breve{H}}_{C , d} {w}_{T}^{*}}{{w}_{T}^{T} ( {σ}_{s}^{2} {\breve{H}}_{C , d}^{H} {q}_{P} {q}_{P}^{H} {\breve{H}}_{C , d} + {σ}_{s}^{2} I ) {w}_{T}^{*}} , \\ using the constraint {‖ {w}_{T} ‖}^{2} = 1 … & Eq . ( 25 )\end{matrix}$$

The cost function above clearly has a Rayleigh quotient form that can be maximized using the generalized eigen-value approach. The solution for the weight vector w_{T} is given as
w_{T}^{o}=u₁*, Eq. (26)
where u₁ is the principal eigenvector of
(σₛ²\check{H}_{C,d}^{H}q_{P}q_{P}\check{H}_{C,d}+σₙ²I)⁻¹\check{H}_{C,d}^{H}\check{H}_{C,d}^{H}. Eq. (27)

The determination of the index p that gives the minimum eigenvalue λ_{B,F} in Equation (23) is next examined. The value of p is determined by the maximum DFT coefficient of the channel vector. But, since the channel vector in this case includes the transmit filter w_{T}, this becomes a circular problem, and an analytical method of determining p is not immediately obvious.

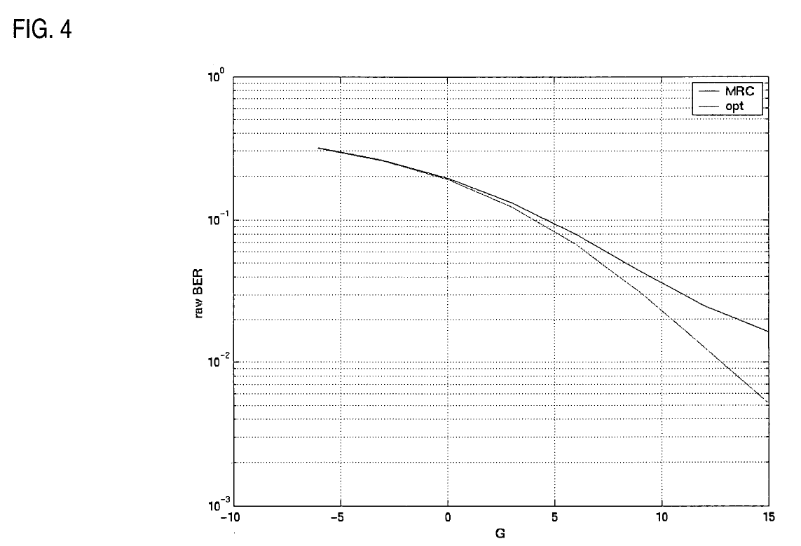

According to one embodiment of the present invention, one approach is to determine p is by brute force, whereby the w_{T} is evaluated for each choice of p, from 1 to F. Next, the resultant cost function is determined for each p. Thus, the p that maximizes the cost function is determined, such that the corresponding value of w_{T} is output for the weights. According to an embodiment of the present invention, an adaptive gradient technique can be utilized, as explained with respect to FIGS. 4-9.

FIG. 3 is a graph showing performance comparison of a weighting scheme that assumes perfect path separability versus the weighting scheme of FIG. 2. Simulations were performed based on adaptive methods. FIG. 3 compares the bit error rates obtained using the weight vector in Eq. (2) with that obtained from Eq. (11). For each realization of the M×1 channel, the weight vector based on Eq. (2) is computed exactly. The second weight vector from Eq. (11) is obtained by using a few hundred iterations of an adaptive algorithm based on the cost function, and the resultant solution is assumed to be the estimated value of the optimal weight vector. These two weight vectors are then used separately in Binary Phase Shift Keying (BPSK) transmissions using the particular channel realization, and the resultant bit errors are noted. The entire procedure is repeated for many realizations of the channel. As seen in FIG. 3, the weight vector yielded by the process of FIG. 2 leads to a better BER performance.

Further simulations were conducted, using the adaptive algorithm, as now described.

Recognizing that a closed form solution may not be practical, an adaptive gradient approach is used, according to an embodiment of the present invention.

The following notation is used in this example: a transmitted chip sequence s excluding other users, transmit weight vector w_{Ta}, receive weight vector w_{R}, multipath channel convolution matrix H, and white gaussian noise n. The received signal is expressed as follows:
r=H(w_{Ta}ΘI_{F′})s+n. Eq. (28)

It is to be noted that the matrix H in the above equation is simply a re-arranged version of the matrix \check{H}ₖ on the right hand side of Eq. (3), and that the transmission weight vector w_{Ta} is a conjugate of the vector w_{T} in Eq. (3). Hence, Eq. (28) is essentially the same as Eq. (6) with minor modifications, and the solution obtained for the transmit vector using the adaptive solution below will simply have to be conjugated to compare with the solution obtained previously.

By assuming receiver filter length F with a delay d, the chip estimate at the receiver can be calculated by using an MMSE criteria; in other words, by minimizing the cost function
J=min||δ_{d}s−w_{R}r||². Eq. (29)

The minimization is performed by setting the following:

$$\frac{\partial J}{\partial {w}_{R}} = 0. \qquad Eq . ( 30 )$$

Solving the above equation results in the following familiar result:

$$\begin{matrix}{w}_{R} = {δ}_{d} {w}_{Ta}^{H} {{H}^{H} ( {σ}_{s}^{2} H ( {w}_{Ta} ⊗ {I}_{{F}^{′}} ) {( {w}_{Ta} ⊗ {I}_{{F}^{′}} )}^{H} {H}^{H} + {σ}_{n}^{2} I )}^{- 1} {σ}_{s}^{2} \\ = {δ}_{d} {w}_{Ta}^{H} {H}^{H} {R}^{- 1} {σ}_{s}^{2}\end{matrix} . \qquad Eq . ( 31 )$$

This equation depends still on the transmit spatial filter w_{Ta}. As explained previously, the receive filter can be used to recalculate the cost function:
J=min σₛ²(1−σₛ²δ_{d}(w_{Ta}ΘI_{F′})^{H}H^{H}R⁻¹H(w_{Ta}ΘI_{F′})δ_{d}^{H}). Eq. (32)

However, the analytical minimization is difficult, and thus, a numerical approach is used.

The minimization problem is basically a constrained optimization problem, which may be solved by using Lagrange multipliers. The constraint in this case is the transmit power constraint i.e. w_{Ta}^{H}w_{Ta}=1 on the cost function J in Eq. (32). Thus, the following equation pair results:

$$\{ \begin{matrix}\frac{\partial J}{\partial {w}_{Ta}^{*}} + \frac{\partial J}{\partial {w}_{T}^{*}} [ {λ}^{*} c ( {w}_{Ta} ) ] = 0 \\ c ( {w}_{Ta} ) = {w}_{Ta}^{H} {w}_{Ta} - 1 = 0\end{matrix} \qquad Eq . ( 33 )$$

By using the definition

$$\frac{\partial J}{\partial {w}_{Ta}^{*}} = 2 ∇ J ,$$

the transmit spatial filter can solved:

$${w}_{Ta} = \frac{1}{{w}_{Ta}^{H} ∇ J} ∇ J . \qquad Eq . ( 34 )$$

However, it is noted that the gradient still depends on a transmit filter to be solved. A numerical algorithm is used to calculate the gradient at a point, and updating the filter gradually. The algorithm is shown in Table 1.

TABLE 1

wᵢ = wᵢₙᵢₜ
For iteration i

Δᵢ = Δg
For each element in J

${∇}_{num} J = \frac{J ( {w}_{i} + {Δ}_{i} ) - J ( {w}_{i} )}{{Δ}_{i}}$

end
${w}_{i + 1} = ( 1 - α ) {w}_{i} + α \frac{1}{{w}_{i}^{H} {∇}_{num} J} {∇}_{num} J$

end

The random variable g ∈[0,1] randomizes the gradient calculation. The gradient is calculated element by element including real and imaginary parts.

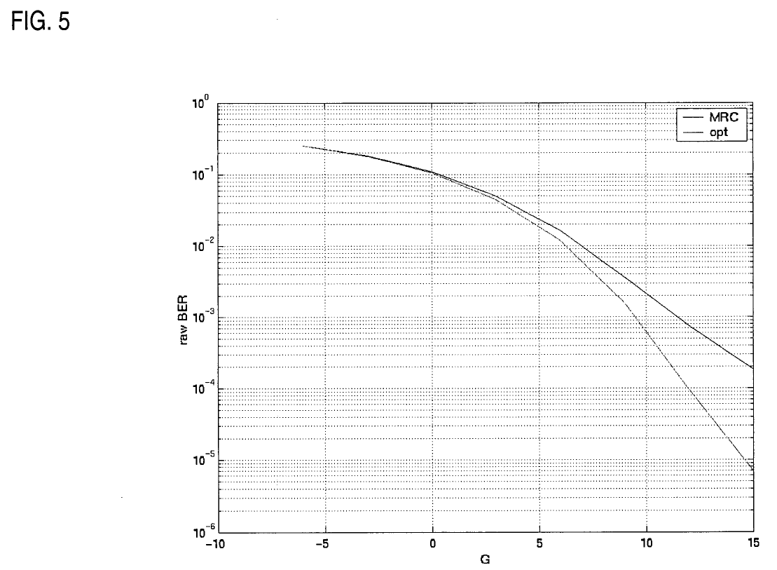

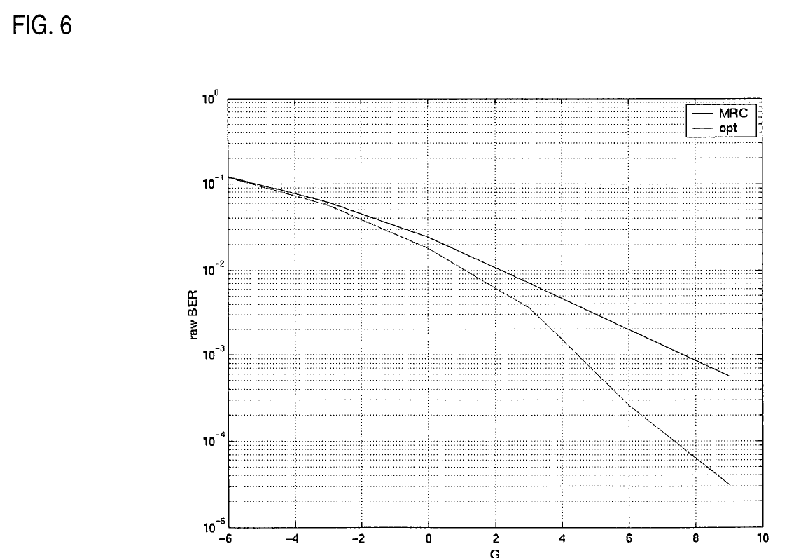

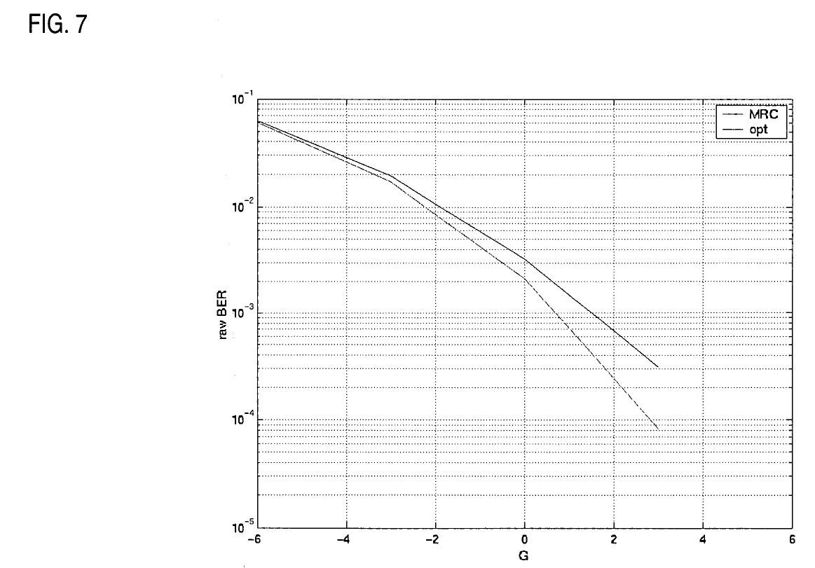

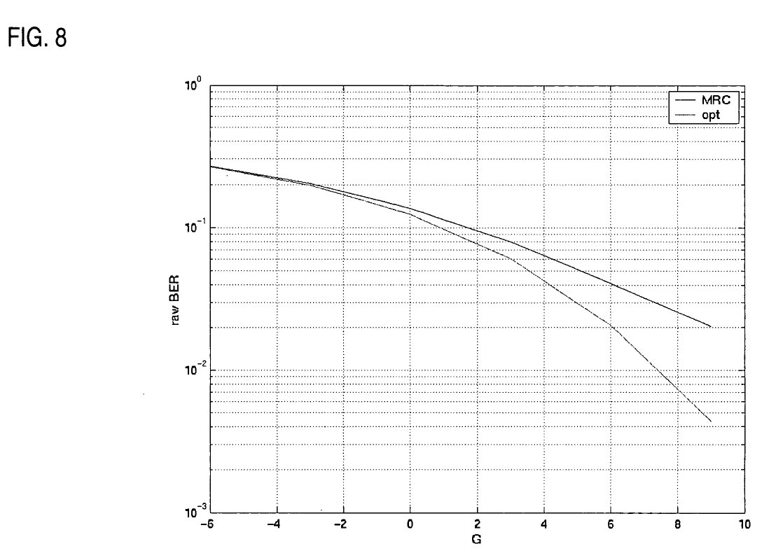

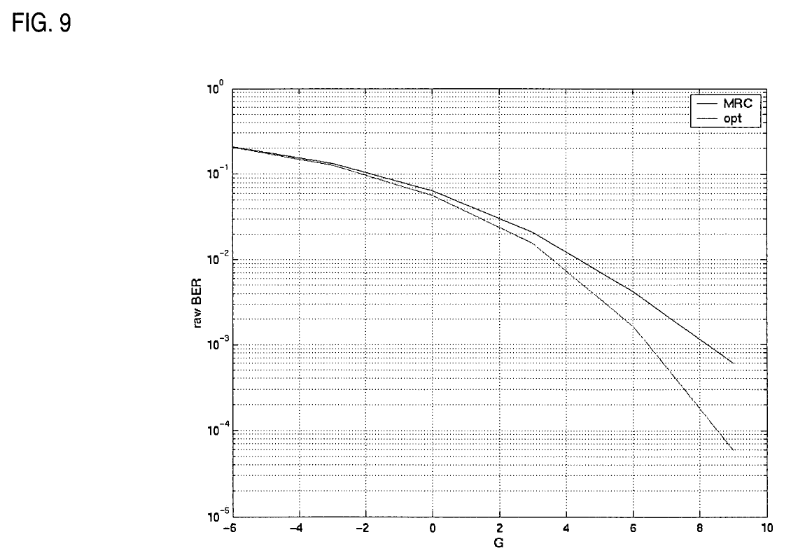

As shown in FIGS. 4-9, the performance of the antenna weighting algorithm of FIG. 2 is compared to the case where feedback is calculated by Maximum Ratio Combiner (MRC) type of combining of RAKE fingers in Wideband Code Division Multiple Access (WCDMA) system. The evaluated schemes include 2×1 2×2, 4×1 and 4×2 single streaming schemes. Specifically, FIG. 3 shows the following scenario: 2×1×1 VA performance, 15 codes, E_{c}/Iₒᵣ=−1 dB. FIG. 5 illustrates a 2×2×1 VA performance, 15 codes, E_{c}/Iₒᵣ=−1 dB. FIGS. 6 and 7 depict, respectively, 4×1×1 and 4×2×1 VA performance (5 codes, E_{c}/Iₒᵣ=−3dB). FIGS. 8 and 9 show, respectively, 4×1×1 and 4×2×1 VA performance (15 codes, E_{c}/Iₒᵣ=−1 dB). Quadrature Phase Shift Keying (QPSK) modulation at spreading factor 16 without channel coding is assumed for these simulations. The improvement in performance due to the optimization scheme of FIG. 2 is mainly visible on relatively high geometry factors. On the other hand, the beamforming itself is able to provide relatively good performance already on low geometry factors. Thus, improvement is usually seen on low bit error rates.

It also observed that the gain depends on the parameter and system settings, but larger gain, generally, is seen with 1 receive antenna compared to 2 receive antenna system. Further, gain due to the optimization process is larger with 4 transmit antennas compared to the use of 2 transmit antennas. If channelization parameters (e.g., E_{c}/Iₒᵣ and number of codes) are set so that low bit error rate requires large G, then the performance gain is also seen at high bit error rates as in FIG. 4 (3 dB gain at 2% Bit Error Rate (BER), 2×1×1 15 codes) and FIG. 8 (3 dB gain at 2% BER, 4×1×1 15 codes).

While allocating 15 multicodes out of 16 and almost full power of −1 dB, the spatial transmit filter optimization gain can be significant, being almost 3 dB at 2% uncoded BER, if 1 receive antenna is used. In general, the performance improvement is modest being at 0.5-1 dB level at 1% uncoded BER. The performance is improved mainly on low bit error rates and high geometry factors. This can also be seen from the convergence analysis where high G factors offer more space for optimization.

As evident from the above discussion, the process of FIG. 2 provides a mechanism for jointly optimizing the transmitter and receiver weights in frequency selective fading channels. The cost function allows the use of a transmit weight vector with a size equal to the number of transmitter of antennas, and independent of the length of the receiver filter. The resultant weighting scheme is shown to perform better when compared, for example, with the principal eigenvector of the stacked channel matrix.

The antenna weighting scheme as detailed above can be executed through a variety of hardware and/or software configurations.

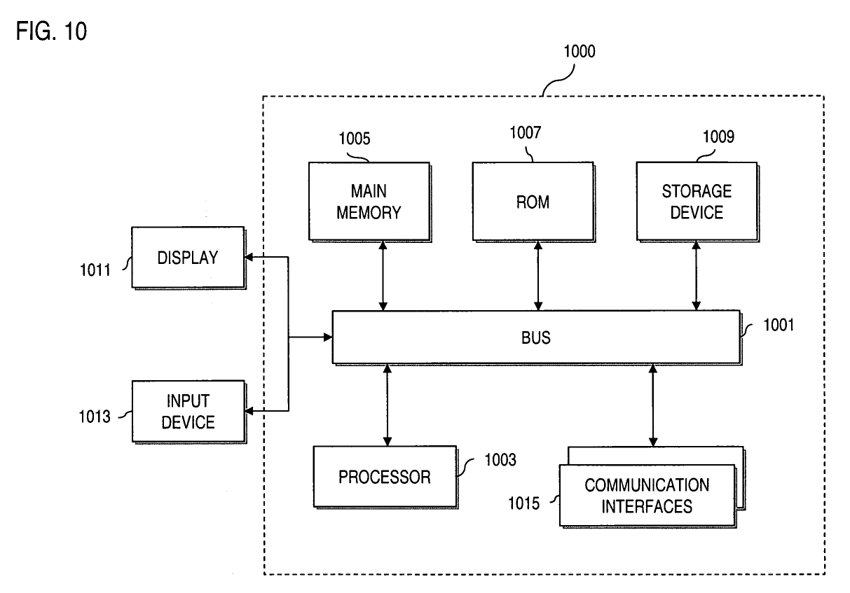

FIG. 10 illustrates exemplary hardware upon which an embodiment according to the present invention can be implemented. A computing system 1000 includes a bus 1001 or other communication mechanism for communicating information and a processor 1003 coupled to the bus 1001 for processing information. The computing system 1000 also includes main memory 1005, such as a random access memory (RAM) or other dynamic storage device, coupled to the bus 1001 for storing information and instructions to be executed by the processor 1003. Main memory 1005 can also be used for storing temporary variables or other intermediate information during execution of instructions by the processor 1003. The computing system 1000 may further include a read only memory (ROM) 1007 or other static storage device coupled to the bus 1001 for storing static information and instructions for the processor 1003. A storage device 1009, such as a magnetic disk or optical disk, is coupled to the bus 1001 for persistently storing information and instructions.

The computing system 1000 may be coupled via the bus 1001 to a display 1011, such as a liquid crystal display, or active matrix display, for displaying information to a user. An input device 1013, such as a keyboard including alphanumeric and other keys, may be coupled to the bus 1001 for communicating information and command selections to the processor 1003. The input device 1013 can include a cursor control, such as a mouse, a trackball, or cursor direction keys, for communicating direction information and command selections to the processor 1003 and for controlling cursor movement on the display 1011.

According to one embodiment of the invention, the process of FIG. 2 can be provided by the computing system 1000 in response to the processor 1003 executing an arrangement of instructions contained in main memory 1005. Such instructions can be read into main memory 1005 from another computer-readable medium, such as the storage device 1009. Execution of the arrangement of instructions contained in main memory 1005 causes the processor 1003 to perform the process steps described herein. One or more processors in a multi-processing arrangement may also be employed to execute the instructions contained in main memory 1005. In alternative embodiments, hard-wired circuitry may be used in place of or in combination with software instructions to implement the embodiment of the present invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the present invention are not limited to any specific combination of hardware circuitry and software.

The computing system 1000 also includes at least one communication interface 1015 coupled to bus 1001. The communication interface 1015 provides a two-way data communication coupling to a network link (not shown). The communication interface 1015 sends and receives electrical, electromagnetic, or optical signals that carry digital data streams representing various types of information. Further, the communication interface 1015 can include peripheral interface devices, such as a Universal Serial Bus (USB) interface, a PCMCIA (Personal Computer Memory Card International Association) interface, etc.

The processor 1003 may execute the transmitted code while being received and/or store the code in the storage device 1009, or other non-volatile storage for later execution. In this manner, the computing system 1000 may obtain application code in the form of a carrier wave.

The term “computer-readable medium” as used herein refers to any medium that participates in providing instructions to the processor 1003 for execution. Such a medium may take many forms, including but not limited to non-volatile media, volatile media, and transmission media. Non-volatile media include, for example, optical or magnetic disks, such as the storage device 1009. Volatile media include dynamic memory, such as main memory 1005. Transmission media include coaxial cables, copper wire and fiber optics, including the wires that comprise the bus 1001. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While the present invention has been described in connection with a number of embodiments and implementations, the present invention is not so limited but covers various obvious modifications and equivalent arrangements, which fall within the purview of the appended claims.

What is claimed is:

1. A method for supporting transmission over a radio communication system, the method comprising:
applying an antenna weight vector to a plurality of antennas, wherein the antenna weight vector is generated by minimizing a cost function based on a transmitted signal and an estimated signal at a receiver, the cost function being jointly optimized according to a transmit filter and a receiver filter of the receiver; and
transmitting a signal via the antennas over the radio communication system to the receiver.

2. A method according to claim 1, wherein the cost function is a mean-squared of a difference between the transmitted signal and the estimated signal.

3. A method according to claim 1, wherein the receiver is a Linear Minimum Mean Square Error (LMMSE) receiver, and the radio communication system is a cellular system.

4. A method according to claim 1, wherein the cost function is minimized according to an adaptive gradient technique.

5. A method according to claim 1, wherein the antenna weight vector has a size equal to the number of the antennas.

6. A computer-readable medium bearing instructions for supporting transmission over a radio communication system, said instructions, being arranged, upon execution, to cause one or more processors to perform the method of claim 1.

7. An apparatus for supporting signal transmission, the apparatus comprising:
a plurality of antennas configured to transmit signals over a radio channel to a receiver; and
antenna weighting circuitry configured to generate an antenna weight vector by minimizing a cost function based on a transmitted signal and an estimated signal at the receiver, the cost function being jointly optimized according to a transmit filter and a receiver filter of the receiver, the circuitry being further configured to apply the generated antenna weight vector to the antennas.

8. An apparatus according to claim 7, wherein the cost function is a mean-squared of a difference between the transmitted signal and the estimated signal.

9. An apparatus according to claim 7, wherein the receiver is a Linear Minimum Mean Square Error (LMMSE) receiver, and the radio channel is a cellular link.

10. An apparatus according to claim 7, wherein the cost function is minimized according to an adaptive gradient technique.

11. An apparatus according to claim 7, wherein the antenna weight vector has a size equal to the number of the antennas.

12. A method for supporting signal transmission, the method comprising:
determining receiver filter weights based on a first set of transmitter filter weights;
modifying a cost function according to the determined receiver filter weights; and
outputting a second set of transmitter filter weights according to the modified cost function, wherein the second set of transmitter filter weights are applied to a plurality of antennas for beamforming.

13. A method according to claim 12, wherein the cost function is a mean-squared of a difference between a signal transmitted by the antennas and an estimate of the signal at a receiver.

14. A method according to claim 13, wherein the receiver is a Linear Minimum Mean Square Error (LMMSE) receiver.

15. A method according to claim 12, wherein the antennas emit signals over a cellular link.

16. A method according to claim 12, wherein the cost function is represented by J=σₛ²(1−w_{T}^{T}\check{H}_{k,d}^{H}R⁻¹\check{H}_{k,d}w_{T}*), w_{T} representing the transmitter filter weights, w_{R} representing the receiver filter weights.

17. A method according to claim 12, further comprising:
executing an adaptive gradient technique to output the second set of transmitter filter weights.

18. A method according to claim 12, wherein the second set of transmitter filter weights has a size equal to the number of the antennas.

19. A method according to claim 12, wherein the second set of transmitter filter weights is independent of length of a receiver filter.

20. A computer-readable medium bearing instructions for supporting signal transmission, said instructions, being arranged, upon execution, to cause one or more processors to perform the method of claim 12.
